(19) United States
(12) Patent Application Publication
(10) Pub. No.: US 2002/0155761 A1
(43) Pub. Date: Oct. 24, 2002

(54) Plug links to determine the height of plugs

(76) Inventors: Alexander Popa, Karlsbad (DE); Thomas Waible, Waldbronn (DE)

Correspondence Address: BAKER & DANIELS, 111 E. WAYNE STREET, SUITE 800, FORT WAYNE, IN, 46802

(21) Appl. No.: 10/016,557

(22) Filed: Dec. 6, 2001

(30) Foreign Application Priority Data
Dec. 8, 2000 (DE) 100 61 475.2

(51) Int. Cl. H01R 13/04

(52) U.S. Cl. 439/692

(57) ABSTRACT

A plug link with a link body and a number of inserted contacts that can be crimped. It is intended here that at least one of the contacts has at least one sideways offset positioning wing to place the uncrimped contact onto at least one contact area in a prespecified height above the link body.

The present invention concerns a plug link.

Plug links are used to position the contact elements, which are to be connected to extension wires, in such a fixed position during the molding of plugs that they will later seat properly in the outlet or the jack. For electrical connectors of varying standards, these contact elements may be contact bars or contact rods, which are oriented towards each other in a basic plug frame and which are then surrounded by injected PVC. In normal plugs, the connection between wire and the contact rods or connectors is typically made by crimping.

The production of the plug must guarantee in each case that a safe connection between the wire and the contact rods can be guaranteed on the one hand and, on the other hand, that the contact rods are held in the proper position in the plug, particularly in the standard position with no possibility of crossing wires.

Plug links are known, where three bar-like contact rods are led through the plug link body to be crimped internally in the body of the plug. Such plug links are produced in accordance with norm UL 1681, for example. The known plug links produce plugs, where the contact rods are initially crimped against the wire ends, with the insulation removed, where the rods are then led through the respective openings in the plug body and are then surrounded by injection as a single unit. Thus, the contact rods must be held in a fixed position, until the PVC has been injected. Given the state of technology, this may lead to considerable tolerances in production, which are often not acceptable. Furthermore, special care needs to be taken to prevent a polarity inversion. Moreover, the production is expensive and certainly very difficult or impossible to fully automate, specifically with respect to pushing the contact bars through the openings.

It is the objective of the present invention to make a new method available for commercial applications.

The solution of the objective is based on independent claims. The independent claims identify preferred embodiments.

A first embodiment of the present invention proposes a plug link with a plug body and contact elements, which pierce the body and which can be crimped, where at least one of the contact elements has at least one sideways offset positioning wing for the positioning of the [illegible] contact area onto at least one contact area in a specified height on the link body.

According to the invention, this will first allow the contacts to be inserted into the link body without falling through, because of the sideways wings, while also guaranteeing an improved positioning of the contacts in the link body. In particular, it guarantees that the contacts can be inserted to a very precise height above the link body and thus the body of the plug.

Thus, the embodiment with its sideways positioning wings according to the invention allows crimping after the contacts have been inserted into the link body. Consequently, the positioning wings, specifically by the high precision of the position of the contacts in the link body, will enable an automatic crimping of all rods in a single step without problems.

It is thus possible per se to form the rim of the injection opening for the contacts itself as the contact area. However, it is preferable that the positioning areas are in contact with separate contact blocks apart from the rim of the injection opening, so that the tolerances in production are improved due to the reduced potential contact area.

It is not necessary that the plug link use only round rods, as for 220 V Euro plugs and the like. Rather, the contacts may well be formed as flat rods or bars, as according to norm UL 1681. A preferred variation uses three flat contact bars to provide for the required 2 phases plus ground (or phase and neutral contact). The contact bars may be offset against each other and, specifically, they may be angled towards each other, as is described in norm UL 1681. The invention allows here for the use of identical contact rods for all contacts, as also possibly for other norms.

In a particularly attractive variation, the positioning surfaces are not identical to the crimp areas and specifically connect the crimp areas with those parts of the contacts, which extend beyond the link body to make contact in the plug or jack. This separation of crimp area and positioning area eliminates any significant movement of the contact during crimping due to bending of the contact metal, for example.

It is possible to produce the contact elements as a single piece or as multiple pieces. The embodiment using multiple pieces enables the use of sheet metal stamping with only minimal waste. This is particularly advantageous, if the contact rods are formed first and the crimp areas second. Both may be permanently connected, possibly through ultrasound welding, embossing or in some other means with electrical conductivity. The boundary from the first to the second part is best positioned along the positioning wings, because their flat surface allows for a particularly [illegible] connection and, furthermore, where the high manufacturing precision of the connection in the wing area does not negatively influence the exact positioning.

It is also preferable, if an area underneath the crimp areas is held open above the link body, because this means that it is easier for the crimp tools to access the crimp wings in the crimp area. Leaving this area open will therefore reduce wear and tear on the crimping tools.

A preferred embodiment includes a channel to lead the bare wires of the stripped wire to or in front of the crimp area to prevent a connection to loose wires and/or to guarantee the proper positioning of the wires from above.

It is preferable that orientation guides be designed into the rim area of the insertion opening, which could guarantee the proper positioning of the contacts, which are asymmetrically arranged due to the positioning surfaces and/or the crimp areas.

Protection is also claimed for a method of production of a plug according to this invention.

The invention is described in the following only by means of examples in drawings. These show:

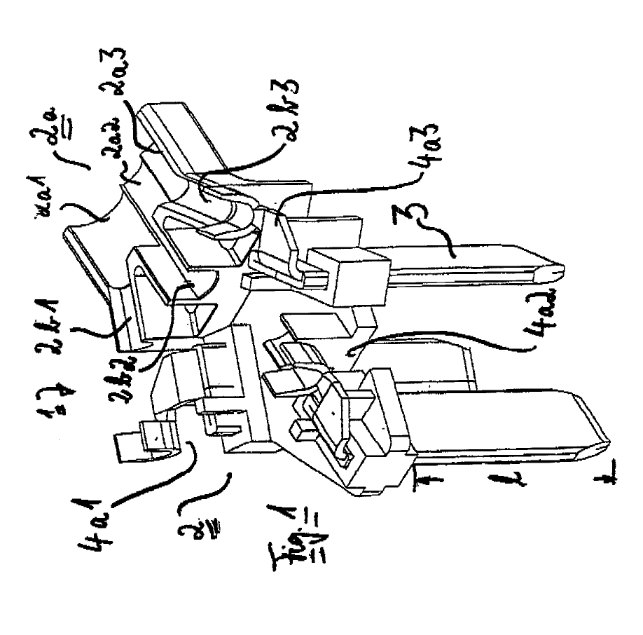

FIG. 1 A plug link according to the present invention without superimposed wire terminals;

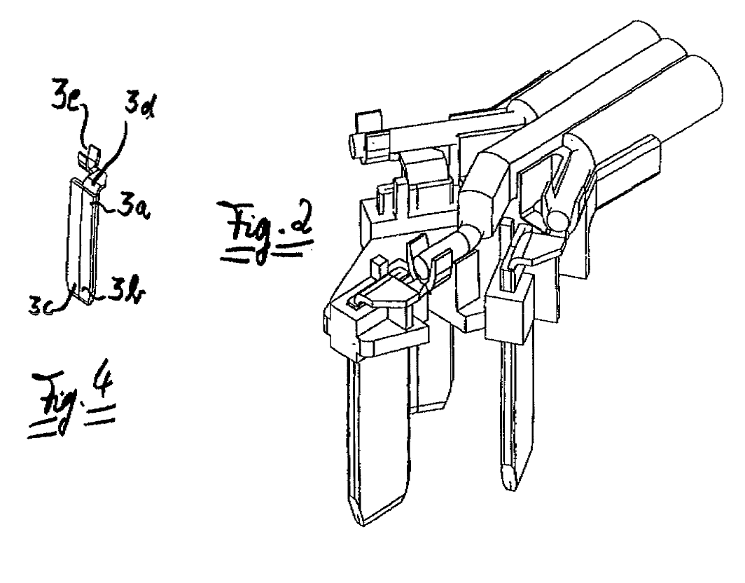

FIG. 2 The plug link of FIG. 1 with superimposed wire terminals prior to crimping;

FIG. 3 The body of the plug;

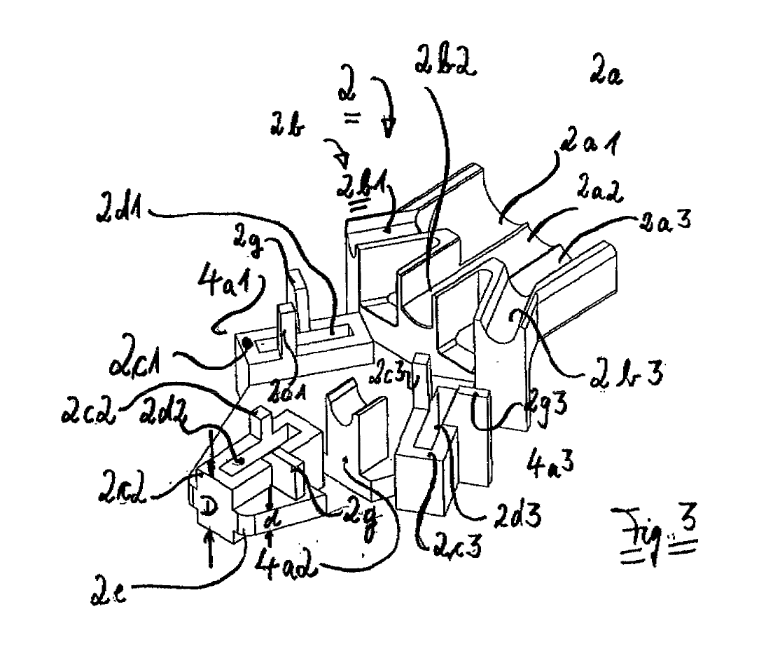

FIG. 4 A contact for insertion into the body of the plug;

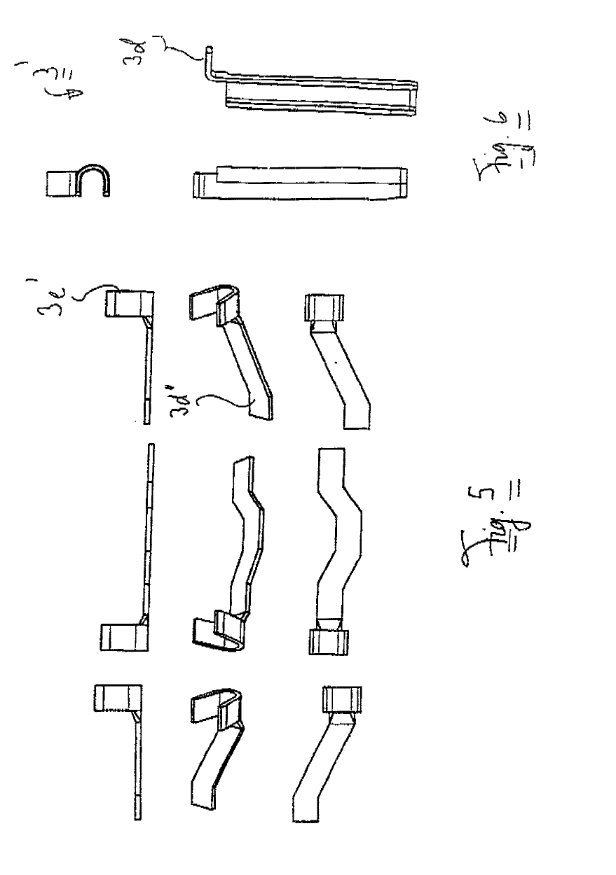

FIG. 5 Components of three different contact elements in three different views;

FIG. 6 An additional component of a contact element in three different views;

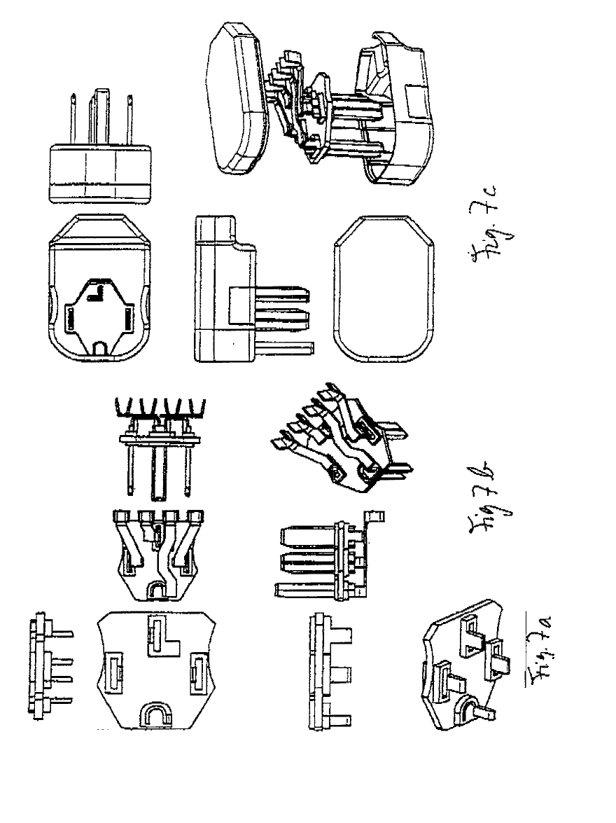

FIG. 7a Views of a link body;

FIG. 7b The link body of FIG. 7a with inserted contact elements;

FIG. 7c The link body with inserted contact elements and associated plug housing;

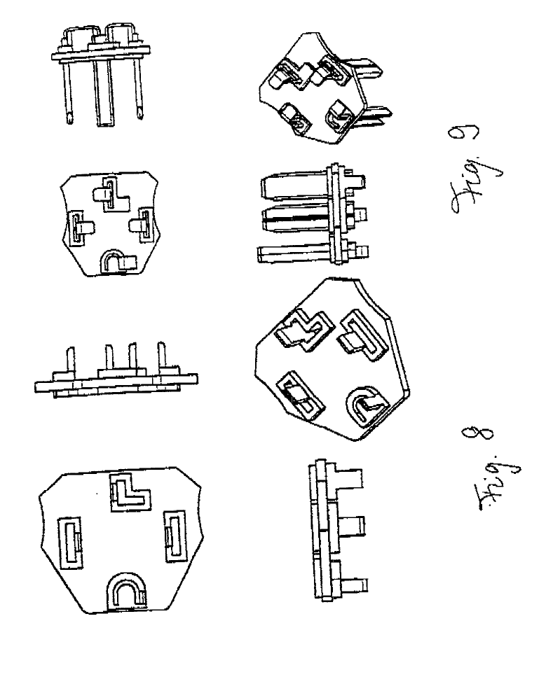

FIG. 8 A link body in four different views for an additional plug link of the present invention;

FIG. 9 The link body with inserted contact elements.

As FIG. 1 shows, the plug link 1, generally designated as 1, includes a link body 2, which consists of three identical connection contacts 3.

The embodiment shown here is the link body (FIG. 3) for a UL link body with 3 contacts designed for 50 Ampere according to norm UL 1681.

The link body 2 is manufactured from a suitable plastic material and contains a wire guide section 2a, by which the wires to be connected are led to the link body. The wire guide section 2a is designed to include three generally parallel channels 2a1, 2a2, and 2a3, in which three isolated wires may be positioned parallel to each other by insertion from above. A transition zone 2b serves to separate the individual isolated wires, as inserted from above, and to lead them to the spaced crimp areas 4a1, 4a2, and 4a3 for a V-crimp.

The link body also contains insertion openings 2d1, 2d2, and 2d3 for the insertion of contacts 3. The crimp areas 4a are here offset sideways relative to the rim 2c of the respective insertion openings 2d. In the area of openings 2d, the link body plate is reinforced towards the top and bottom to such an extent that it is guaranteed that the contact inserted into opening 2d will generally remain vertical relative to the link body base without major angle deviation. The reinforcement is identified as the reinforcement D or d in FIG. 2.

On the rim 2c of the insertion openings and associated with them, there are two different stops 2e and 2g. Stop 2e is offset from the longitudinal middle of the rim of the insertion opening 2c to preclude an erroneous insertion of the contacts. The stop 2g is placed in the middle of rim 2c of the insertion opening.

As FIG. 4 shows, the contact 3 is formed as a single unit from a brass sheet metal piece. Contact 3 includes a flat insertion end 3a with tapered leading edges 3b for insertion into the link body insertion opening 2d and for insertion into a plug. At the end 3a to be inserted, the contact 3 is formed by folding together sheet metal, as is indicated by the doubled area 3c in FIG. 4.

Across half the width of contact 3, but for more than the doubled area 3c, the insertion end 3a extends upwards such that the contact 3 has a wing area 3d, which ends with a positioning wing that extends vertically from the contact end 3a and that leads from there to a crimp area 3e for the incoming V-crimp.

As FIG. 1 shows, the contacts 3 are formed such that the positioning wings 3d will make contact with the surfaces of the positioning areas 2g when the contacts are inserted through the insertion slots, such that the contact terminal is held in the required distance above the link body. The length of the contacts below the link body, shown in FIG. 1 as the distance 1, is thus determined precisely by the interaction of positioning wings 3d and the positioning areas 2g.

Any potentially erroneous insertion of the identical contacts 3 into the link body 2 through the insertion slots 2d is precluded by the blocks 2e. The contacts 3 will thus be inserted into the link body such that the crimp wings of contacts 3 will always be properly situated above the open crimp area 4a, i.e. the gap in link body 2. The contacts 3 are thus positioned appropriately.

The plug link of the present invention is produced and processed as follows:

Initially produce a link body 2, as described above, from suitable plastic material. Then produce contacts as shown in FIG. 4. Now insert these into the link body and produce a large number of link bodies from further processing. Remove the insulation from the wire ends of a cable and insert the cable from above into the wire guides 2a such that the wire ends are automatically positioned in the V-shaped crimp openings 3c. Now undertake the crimping of the wire ends with a suitable tool that is pushed through the openings 4a of the link body onto the crimp wings 3c. It is preferable that this action be done for all crimp wings in a single step.

Finally inject material around the prefabricated elements. The arrangement according to the invention prevents the inadvertent confusion of contacts, while the spacing of contacts during crimping and the positioning of the wires in the link body prevent a potential short or a similar problem. The positioning of the wires in the wire guide also provides a better stress relief.

Even though FIG. 4 shows contact elements that are shaped as single units with the crimp area and positioning wings made from a single piece of metal, it is also possible to produce the contact elements from two pieces.

FIGS. 7a to 7c show a further example of another plug, where the link body has contact blocks that are not identified here by reference labels to avoid confusion, but which are shown in FIG. 7a. FIG. 7b shows that the positioning surfaces or wings of the contact elements are pushed against the contact blocks. The contact elements themselves are produced in two pieces here, namely with a first crimp area, which is shown in various shapes in FIG. 5 as examples, and contact rod areas, of which one example is shown in FIG. 6 in various views.

The contact element 3′ now includes a connection area 3d′, which is intended to lie flush against the contact of the link body in order to assure the proper height or length of the contacts below the link body. The crimp areas of FIG. 5 have a crimp wing 3e′ on one end and a connection area 3d″ on the opposite end, where the crimp area components are to be connected with the contact rod elements. The individual components are to be stamped from appropriate sheet metal with minimal material waste and are formed such that they can be permanently connected to areas 3d′ and 3d″ by embossing, ultrasound welding or other methods with electrical conductivity.

The two parts may be manufactured separately in a production step to produce the contact elements and may be permanently connected prior to insertion into the link body. This can be done with high precision, which in turn allows for a precise positioning of the contact elements in the link body. The contact elements may then be crimped with the wires. The crimping may be done simultaneously for all wires on one side of the link body.

The use of this invention is particularly advantageous for a certain geometry, but it is not restricted to that geometry, but may rather be used for a number of geometries, such as is shown in an additional example in FIG. 8 and 9, where the contact elements of FIG. 9 are inserted without crimp areas.

Patent claims

1. A plug link with a link body and contact elements inserted through it, which can be crimped, characterized by having at least one of the contact elements that has at least one sideways offset positioning wing that positions the uncrimped contact element on the contact area in a prescribed distance from the link body.

2. A plug link according to the preceding claim designed such that the positioning wings are in contact with contact areas in proximity to the insertion slits.

3. A plug link according to the preceding claim characterized by having at least one of the contact elements as a flat contact rod or contact bar.

4. A plug link according to one of the preceding claims characterized by having several identical contact bars, which are produced in identical fashion.

5. A plug link according to one of the preceding claims characterized by having three contact bars.

6. A plug link according to one of the preceding claims characterized by having the contact bars offset against each other.

7. A plug link according to one of the preceding claims characterized by having the contact bars positioned at an angle against each other.

8. A plug link according to one of the preceding claims characterized by having a space between the positioning areas and the crimp areas.

9. A plug link according to one of the preceding claims characterized by having a contact area with contact wings in a first part, a crimp area in a second part, and a permanent connection of both parts to the contact element.

10. A plug link according to one of the preceding claims characterized by having a connection from the crimp areas to the positioning wings to the contacts inserted into the link body.

11. A plug link according to one of the preceding claims characterized by having an open space immediately below the crimp areas.

12. A plug link according to one of the preceding claims characterized by having the crimp areas offset sideways and axially from the contacts.

13. A plug link according to one of the preceding claims characterized by having a wire guide system immediately in front of the crimp area, so that the bare wire can be positioned in the crimp area.

14. A plug link according to one of the preceding claims to satisfy the UL norm UL 1681.

15. A plug link according to one of the preceding claims characterized by having orientation blocks to preclude insertion of the contacts in a wrong orientation.

16. A process to produce a plug link characterized by providing a link body with contact insertion slits and contact areas in proximity to the insertion slits, by inserting contacts with sideways offset positioning areas and a crimp area into such insertion slits that the sideways offset positioning areas contact the contact areas, by leading wire terminals to the crimp areas and by crimping them.
